(19) United States
(12) Patent Application Publication
(10) Pub. No.: US 2016/0049668 A1
(43) Pub. Date: Feb. 18, 2016

(54) FUEL CELL WITH IMPROVED REACTANT DISTRIBUTION

(71) Applicant: GM GLOBAL TECHNOLOGY OPERATIONS LLC, Detroit, MI (US)

(72) Inventors: PINKHAS A. RAPAPORT, PENFIELD, NY (US); IVAN D. CHAPMAN, ROCHESTER, MI (US); WILLIAM H. PETTIT, ROCHESTER, NY (US)

(21) Appl. No.: 14/461,014

(22) Filed: Aug. 15, 2014

(51) Int. Cl. H01M 8/02; B60L 11/18

(52) U.S. Cl. CPC H01M 8/0258; B60L 11/1883; B60L 11/1898; H01M 2250/20

(57) ABSTRACT

Systems and methods are disclosed that provide for a bipolar plate for a fuel cell system that includes cross flow channels facilitating reactant flow between primary reactant flow channels. In certain embodiments, the cross flow channels may allow for improved reactant flow distribution across catalyst layers of the fuel cell system. In further embodiments, the cross flow channels may increase a reaction interface area in the fuel system, thereby improving the performance of the system.

### TECHNICAL FIELD

This disclosure relates to fuel cell systems. More specifically, but not exclusively, this disclosure relates to a fuel cell stack assembly utilizing cross flow channels to improve reactant distribution within the fuel cell system.

### BACKGROUND

Passenger vehicles may include fuel cell (“FC”) systems to power certain features of a vehicle's electrical and drivetrain systems. For example, an FC system may be utilized in a vehicle to power electric drivetrain components of the vehicle directly (e.g., electric drive motors and the like) and/or via an intermediate battery system. An FC system may include a single cell or, alternatively, may include multiple cells arranged in a stack configuration.

FC systems may include one or more individual fuel cells provided between bipolar plates-separators in a FC stack. The bipolar plates may define a plurality of parallel primary flow channels facilitating reactant flow distribution across a catalyst layer area in the FC stack cells. In certain embodiments, the design of these flow channels may include a channel/land configuration (i.e., a rib and channel configuration). The flow channels may facilitate reactant distribution in an active area of the FC, while the ribs and/or land areas that separate the flow channels may provide mechanical support for certain elements in the FC stack including gas diffusion layers. In certain embodiments, the flow channels may include serpentine, interdigitated, and/or straight channel configurations.

Conventional channel and land configurations, while assuring the uniformity of reactant flow through the primary flow channels, may reduce interface areas between reactant and catalyst layers, thereby reducing the potentially achievable performance. Moreover, reduction of catalyst area engaged in reaction can detrimentally affect the operation associated FC system (e.g., by increasing localized excessive current densities and/or impact reactant distribution which may reduce durability). For example, in a straight flow channel configurations, reactant convection through gas diffusion layers disposed under land areas may be reduced. This may limit reactant access to the catalyst under the rib due to lower diffusion through compressed gas diffusion layer. When the FC system operates at low temperatures, water may condense in the gas diffusion layers under land areas, thereby decreasing local gas permeability and further reducing utilized active catalyst surface areas and performance of such flow fields at higher current densities.

In interdigitated channel configurations (e.g., channel configurations wherein every other channel is connected to an inlet manifold and the rest of the channels are connected to an outlet manifold), the fraction of utilized active catalyst surface under land areas is increased due to unregulated convection of reactants between inlet and outlet channels under the land. However, in this case significant pressure drop increase and/or decrease in volumetric power density may also be introduced.

In flow field designs without defined land and/or channel patterns, reactant flow may be distributed via a layer of conductive foam and/or mesh. Such designs may increase active catalyst surface area accessible to reactants, but may also involve certain design concessions and/or increased cost to achieve more uniform reactant flow distribution. In view of the above, systems and methods that facilitate improved reactant flow distribution across catalyst layers of the FC stack while reducing performance issues and/or costs are desirable.

### SUMMARY

Embodiments of the systems and methods disclosed herein provide for an FC stack assembly comprising a plurality of FCs (e.g., proton exchange membrane FC (“PEMFC”) systems including a proton exchange membrane with an anode catalyst layer on one side and cathode catalyst layer on other side sandwiched between anode and cathode gas diffusion layers) separated from each other by bipolar plates having land channel flow field configurations for at least one of the reactant flows. As used herein, such lands and channels of the flow field may, in certain instances, be further referred as primary lands and channels. Certain embodiments may comprise cross flow channels between primary flow channels. In certain embodiments, the cross flow channels may facilitate improved reactant flow distribution across catalyst layers of the FC stack and/or increase interface area between reactant and catalyst layers, thereby improving FC system performance. For example, in some embodiments, connecting adjacent primary flow channels with cross flow channels may improve FC system performance by increasing utilization of catalyst layer areas, reducing localized excessive current densities in the FC system, and/or improving FC system durability. Embodiments disclosed herein may further improve FC performance at low temperatures, FC performance during extra wet operation, FC performance at low platinum loading, and/or compatibility with thinner gas diffusion media materials and/or other membrane electrode assembly materials.

In some embodiments, the cross flow channels may be defined by in either anode or cathode side or both side flow fields of the bipolar plates of the FC stack. For example, in certain embodiments, the cross flow channels may be defined, at least in part, within one or more land areas associated with the bipolar plates of the FC stack. In certain embodiments, portions of cross flow channels defined within lands of the bipolar plates may be sufficiently deep to allow for reactants to pass through the cross flow channels between the bipolar plate and a gas diffusion media. That is, reactants may flow freely through the cross flow channels between parallel primary flow channels defined by the bipolar plate. In further embodiments, portions of gas diffusion media may intrude within cross flow channels defined within land areas of a bipolar plate. These portions of gas diffusion media may be less compressed and/or otherwise more permeable than other portions of gas diffusion media disposed under lands of the bipolar plate. Accordingly, reactants may flow through the less compressed and/or otherwise more permeable gas diffusion media within the cross flow channels between the primary flow channels.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a perspective view of an FC stack consistent with embodiments disclosed herein.

FIG. 2 illustrates a perspective view of a portion of a sheet of a bipolar plate including cross flow channels consistent with embodiments disclosed herein.

FIG. 3 illustrates a cross-sectional view of a plurality of exemplary cross flow channels consistent with embodiments disclosed herein.

FIG. 4 illustrates a top view of a cross flow channel configuration consistent with embodiments disclosed herein.

FIG. 5 illustrates a graph showing exemplary normalized performance increase for a FC stack at a variety of exemplary cross flow channel aspect ratios consistent with embodiments disclosed herein.

FIG. 6 illustrates a flow chart of an exemplary method of assembling an FC stack consistent with embodiments disclosed herein.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Embodiments of the systems and methods disclosed herein provide for an FC stack assembly comprising bipolar plates/separators that include cross flow channels between primary flow channels. In certain embodiments, the cross flow channels may facilitate improved reactant flow distribution across catalyst layers of the FC stack and/or increase interface areas between reactants and catalyst layers, thereby improving FC system performance. A variety of suitable cross flow channel widths, depths, orientations (e.g., perpendicular or angled relative to primary channels) and/or frequencies may be utilized in connection with the disclosed embodiments. In some embodiments, the specific configurations of the cross flow channels may be based, at least in part, on geometries of associated primary flow channels.

Certain embodiments may be utilized in conjunction with a PEMFC system, although other types of FC systems may also be utilized. In a PEMFC system, hydrogen may be supplied to an anode of the FC, and oxygen may be supplied as an oxidant to a cathode of the FC. A PEMFC may include a membrane electrode assembly (“MEA”) including a proton but not electron conductive solid polymer electrolyte membrane having an anode catalyst on one of its faces and a cathode catalyst on the opposite face. The membrane may be sandwiched between anode and cathode gas diffusion layers to form the MEA. The MEA may be disposed between a pair of electrically conductive elements forming portions of a bipolar plate and serving as current collectors for the anode and cathode. The bipolar plates may define one/or more primary flow channels and/or cross flow channels for distributing the gaseous reactants over the surfaces of the respective anode and cathode catalyst layers.

An FC system may include a single cell or, alternatively, may include multiple cells arranged in a stack configuration. For example, in certain embodiments, multiple cells may be arranged in series to form an FC stack. In an FC stack, a plurality of cells may be stacked together in electrical series and be separated by gas impermeable, electrically conductive bipolar plates. The bipolar plate may perform a variety of functions and be configured in a variety of ways. In certain embodiments, the bipolar plate may define one or more internal cooling passages and/or channels including one or more heat exchange surfaces through which a coolant may flow to remove heat from the FC stack generated during its operation.

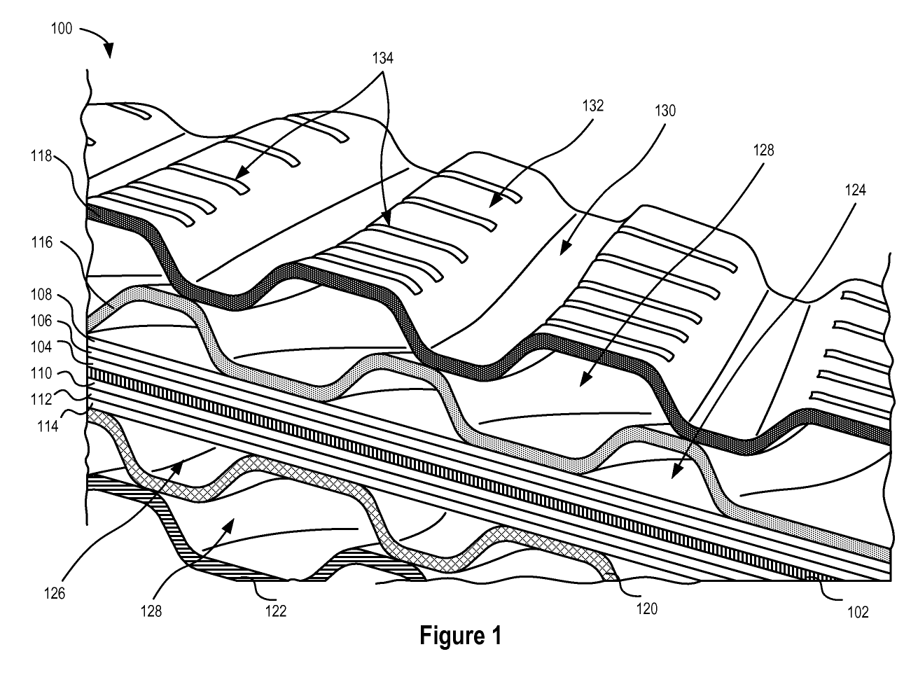

FIG. 1 illustrates a perspective view of an FC stack 100 consistent with embodiments disclosed herein. The FC stack 100 may, among other things, be a FC stack 100 of a FC system included in a vehicle. The vehicle may be a motor vehicle, a marine vehicle, an aircraft, and/or any other type of vehicle, and may include any suitable type of drivetrain and/or stationary power supply for incorporating the systems and methods disclosed herein. The FC system may be configured to provide electrical power to certain components of the vehicle and/or or other electrically powered device collectively described herein as FC powered equipment (“FCPE”). For example, the FC system may be configured to provide power to electric drivetrain components of the vehicle. The FC stack 100 may include a single cell or multiple cells arranged in a stack configuration, and may include certain FC system elements and/or features described above. In particular, FIG. 1 illustrates a cross section of a portion of an FC stack 100 that includes a single FC.

The FC may comprise a cathode and an anode separated by a proton exchange membrane (“PEM”) 102. The cathode may comprise a cathode side catalyst layer 104 disposed against a first side of the PEM 102, a cathode side microporous layer 106 disposed against the cathode side catalyst layer 104, and a cathode side diffusion media layer 108 disposed against the cathode side microporous layer 106. The anode of the FC may comprise an anode side catalyst layer 110 disposed against a second side of the PEM 102, an anode side microporous layer 112 disposed against the anode side catalyst layer 110, and an anode side diffusion media layer 114 disposed against the anode side microporous layer 112.

FCs of the FC stack 100 may be stacked together in electrical series and be separated by gas impermeable electrically conductive bipolar plates. The bipolar plates may comprise a plurality of sheets. For example, a first bipolar plate may comprise sheets 116, 118 and a second bipolar plate may comprise sheets 120, 122. In certain embodiments, sheets 116-122 may be manufactured in a variety of ways including, machining, molding, stamping, and/or the like. Sheets 116-122 may be further affixed together through a welding and/or any other bonding process. For example, sheets 116 and 118 may be welded together at certain interface locations. Similarly, sheets 120 and 122 may be welded together at certain interface locations.

The bipolar plates and/or the constituent sheets 116-122 may comprise any suitable material including, for example, steel, stainless steel, titanium, aluminum, carbon, graphite and/or the like. In further embodiments, the bipolar plates and/or the constituent sheets 116-122 may comprise a material that includes a conductive protective coating configured to mitigate degradation of the bipolar plates and/or the constituent sheets 116-122 during operation of an associated FC system.

In certain embodiments, a cathode side of the first bipolar plate may be defined by sheet 116. Similarly, an anode side of the second bipolar plate may be defined by sheet 120. Sheet 116 may define a plurality of primary cathode side flow channels 124. Similarly, sheet 120 may define a plurality of parallel primary anode side flow channels 126. Cathode reactant (e.g., oxygen and/or air) may flow through the parallel primary cathode side flow channels 124 and anode reactant (e.g., hydrogen) may flow through the parallel primary anode flow channels 126. The cathode reactant (e.g., oxygen and/or air) may diffuse through the cathode side diffusion media layer 108 and the cathode side microporous layer 106 and react with the cathode side catalyst layer 104. The anode reactant (e.g., hydrogen) may diffuse through the anode side diffusion media layer 114 and the anode side microporous layer 112 to react with the anode side catalyst layer 110. Hydrogen ions may propagate through the PEM 102, thereby creating an electric current.

In certain embodiments, sheet 118 of the first bipolar plate may define a plurality of parallel primary flow channels of an anode side of an adjacent FC (not shown) of the FC stack 100. Similarly, sheet 122 of the second bipolar plate may define a plurality of parallel primary flow channels of a cathode side of another adjacent FC (not shown) of the FC stack 100. In some embodiments, the sheets 116, 118 of the first bipolar plate and the sheets 120, 122 of the second bipolar plate may define a plurality cooling fluid follow channels 128 for facilitating flow of liquid coolant during operation of the FC stack 100.

In some embodiments, the sheets 116-122 may comprise a plurality of land areas and channel areas. For example, as illustrated, sheet 118 may comprise a plurality of land areas 132 and a plurality of channel areas 130. Channel areas may, at least in part, define one or more parallel primary flow channels of an associated bipolar plate. For example, channel areas 130 of sheet 118 may define, at least in part, a plurality of parallel primary anode side flow channels of an anode side of an adjacent FC (not shown) of the FC stack. 100. Land areas may interface with an anode and/or cathode of a FC and/or gas diffusion media associated with the same. The land areas may, among other things, provide support for adjacently disposed gas diffusion media and/or adjacent channel areas. For example, land areas 132 of sheet 118 may interface with an anode side gas diffusion media layer of an adjacent FC (not shown) of the FC stack 100.

In conventional designs, reactant flow within the FC stack 100 may be contained substantially within primary flow channels 124, 126 defined by the bipolar plates. In such designs, reactant flow may be substantially reduced and/or eliminated in portions of gas diffusion media disposed adjacent to land areas defined by the bipolar plates. For example, in certain circumstances, gas diffusion media disposed adjacent to land areas defined by the bipolar plates may be substantially compressed, thereby rendering the gas diffusion media substantially less permeable to reactant flow. This may, among other things, reduce the uniformity of reactant flow through the FC stack 100 and/or the primary flow channels 124, 126 and/or reduce reaction interface areas, thereby detrimentally affecting performance of an associated FC system.

Consistent with embodiments disclosed herein, bipolar plates of the FC stack 100 may further define a plurality of cross flow channels 134. In certain embodiments, the cross flow channels 134 may facilitate improved reactant flow across catalyst layers 104, 110 of the FC stack 100. Particularly, the cross flow channels 134 may allow for increased flow of reactant between adjacent parallel primary flow channels 124, 126 of the bipolar plates. For example, as illustrated, cross flow channels 134 may define a reactant flow path across land areas 132 of sheet 118 between parallel channel areas 130, thereby allowing for increased flow of reactant between adjacent parallel primary flow channels defined by sheet 118 and increased reaction interface areas.

In some embodiments, the cross flow channels 134 may be defined in land areas 132 of the bipolar plate, thereby facilitating improved reactant flow across the land areas 132. In further embodiments, the cross flow channels 134 may also be defined in channel areas 130 and/or interface areas (i.e., channel walls) between the channel areas 130 and the land areas 132 of the bipolar plate.

In some embodiments, the cross flow channels 134 may allow for reactants to flow freely between parallel primary flow channels. That is, the cross flow channels 134 may allow reactants to flow within the cross flow channels 134 without permeating any gas diffusion media disposed within the cross flow channels 134. In further embodiments, gas diffusion media may intrude into the cross flow channels 134, but reactant flow may still be facilitated within the cross flow channels 134 through the gas diffusion media. For example, gas diffusion media that intrudes into the cross flow channels 134 may be less compressed and/or otherwise more permeable to reactants than other portions of gas diffusion media disposed adjacent to other land areas 132, thereby allowing for reactant flow within the cross flow channels 134 through the gas diffusion media.

In certain embodiments, cross flow channels 134 may be incorporated between both primary cathode side flow channels 124 and primary anode side flow channels 126. In further embodiments, cross flow channels 134 may be incorporated between either primary cathode side flow channels 124 or primary anode side flow channels 126.

In some embodiments, incorporation of cross flow channels 134 between primary flow channels 124, 126 may depend on a diffusion coefficient of an associated reactant. For example, a cathode reactant, such as oxygen and/or air, may have a lower diffusion coefficient than an anode reactant such as hydrogen. Accordingly, in certain embodiments, cross flow channels 134 may be included only between primary cathode side flow channels 126. In other embodiments, an increased number of cross flow channels 134 may be included between primary reactant flow channels on a FC side (i.e., anode or cathode) associated a reactant having a lower diffusion coefficient than the reactant associated with the other FC side. In yet further embodiments, a geometry the cross flow channels 134 may depend on a diffusion coefficient of an associated reactant. For example, cross flow channels 134 associated with a reactant having a lower diffusion coefficient may have a larger geometry than cross flow channels 134 associated with a reactant having a higher diffusion coefficient. In this manner, the inclusion of cross flow channels 134, the number and/or position of cross flow channels 134, and/or a geometry of cross flow channels 134 may depend on a diffusivity of an associated reactant (e.g., air, oxygen, Hydrogen, reformate, etc.).

As discussed above, in certain embodiments, the geometry of the disclosed cross flow channels 134 (e.g., depth, pitch and/or angle of channel walls, spacing, width, etc.) may depend, at least in part, on the diffusivity of an associated reactant. In further embodiments, the geometry of cross flow channels 134 may depend, at least in part, on a material used to form the associated bipolar plate and/or its constituent sheets 116-122 and/or associated manufacturing processes. For example, a sheet of a bipolar plate defining the cross flow channels 134 and/or primary reactant flow channels 124, 126 may be stamped, molded, and/or machined to achieve a desired shape by introducing one or more bends. In certain embodiments, introducing a bend in the sheets 116-122 (e.g., via stamping) may cause necking, whereby a thickness of the sheets 116-122 may be reduced proximate to the introduced bend. Necking may be influenced by a variety of factors including, without limitation, bend radius and/or sheet material. For example, decreasing bend radius may introduce increased necking. Accordingly, geometries of cross flow channels 134 consistent with embodiments disclosed herein may be designed to account for effects of necking of a particular material used to form a bipolar plate.

It will be appreciated that a number of variations can be made to the embodiments of the disclosed FC stack 100 presented in connection with FIG. 1 within the scope of the inventive body of work. For example, cross flow channels 134 consistent with embodiments disclosed herein may be integrated into FC stacks 100 having a variety of other geometries and/or configurations. Thus it will be appreciated that FIG. 1 is provided for purposes of illustration and explanation and not limitation.

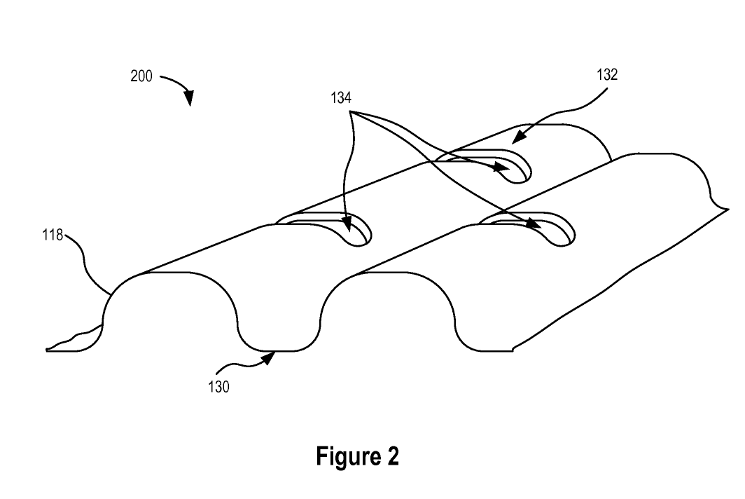

FIG. 2 illustrates a perspective view of a portion 200 of a sheet 118 of a bipolar plate including cross flow channels 134 consistent with embodiments disclosed herein. As illustrated, sheet 118 may comprise a plurality of land areas 132 and a plurality of channel areas 130. Channel areas 130 may, at least in part, define one or more primary flow channels of an associated bipolar plate. Consistent with embodiments disclosed herein, one or more cross flow channels 134 may be included in the land areas 132 that allow for increased flow of reactant between adjacent primary flow channels and/or increased utilization of active catalyst area surface area. For example, as illustrated, cross flow channels 134 may define a reactant flow path across land areas 132 of sheet 118 between parallel channel areas, thereby allowing for increased flow of reactant between adjacent parallel primary flow channels defined by sheet 118 and increased reaction interface areas.

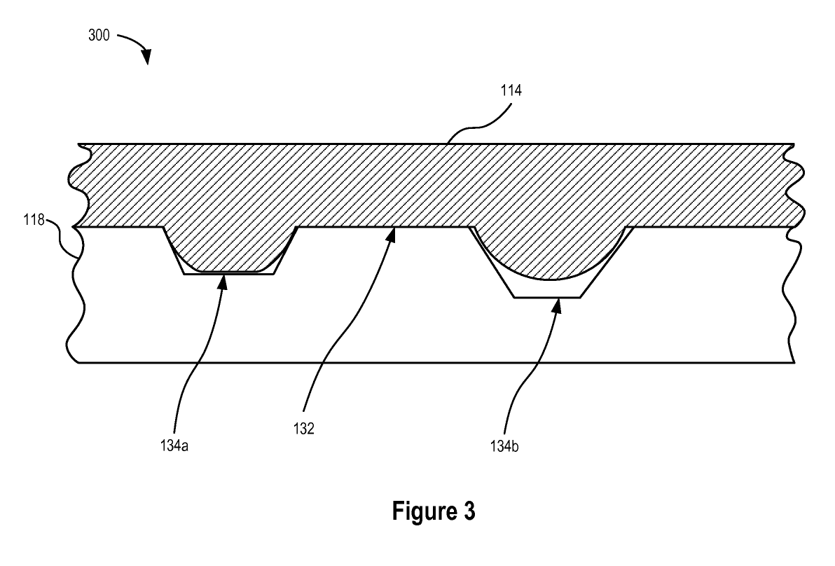

FIG. 3 illustrates a cross-sectional view 300 of a plurality of exemplary cross flow channels 134a, 134b consistent with embodiments disclosed herein. As discussed above, cross flow channels 134a, 134b formed in land areas 134 consistent with embodiments disclosed herein may have a variety of geometries. For example, the depth of the cross flow channels 134a, 134b can vary from relatively shallow, whereby local compression of an associated diffusion media layer 114 may be reduced and local diffusion may be enhanced, to relatively deep, whereby some cross land clearance through the cross flow channels 134a, 134b may permit convection of reactants through the cross flow channels.

In the illustrated exemplary cross flow channels 134a, 134b, cross flow channel 134a may be relatively shallow, thereby allowing portions of the diffusion media layer 114 to intrude within the cross flow channel 134a with less local compression. Accordingly, reactants may flow through the less compressed and/or otherwise more permeable gas diffusion media 114 disposed within the cross flow channel 134a. Cross flow channel 134b may be relatively deep, thereby allowing convection of reactant through the cross flow channel 134b between associated parallel primary flow channels.

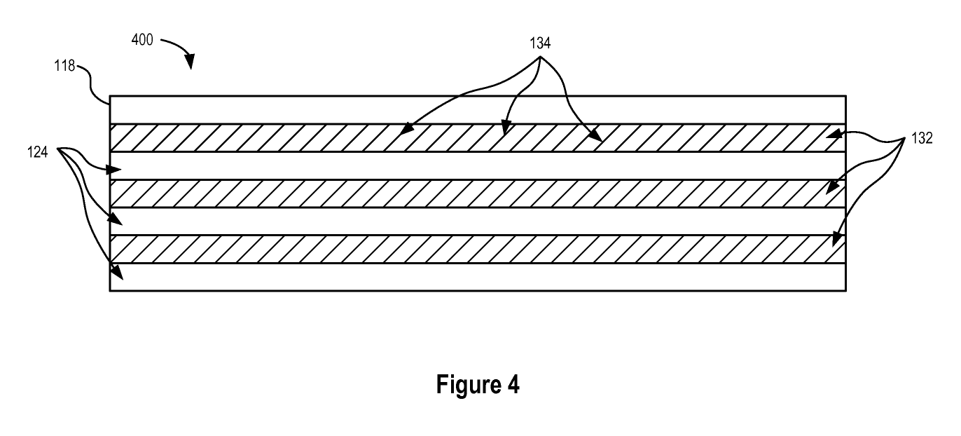

FIG. 4 illustrates a top view 400 of a cross flow channel configuration consistent with embodiments disclosed herein. Consistent with embodiments disclosed herein, one or more cross flow channels 134 may be disposed in land areas 132 of a sheet 118 facilitating improved reactant flow distribution (e.g., reactant flow between primary flow channels 124). In certain embodiments, cross flow channels 134 may be disposed perpendicular relative to adjacent primary flow channels 124. In the illustrated embodiments, cross flow channels 134 may be disposed at any suitable angle relative to adjacent primary flow channels 124 (e.g., at 45-90 degree angle relative to the primary flow channels 130). Although illustrated as being uniformly spaced along the primary flow channels 124, in other embodiments, spacing of cross flow channels 134 and/or other cross flow channel geometries (e.g., width, pitch, and/or depth) may vary along the length of the primary flow channels 124 (e.g., starting with larger spacing over a first portion of the flow field and smaller spacing over a second portion of the flow field, thereby facilitating increased diffusion access where reactants may be more depleted).

In other embodiments, features may be introduced in the primary flow channels 124 that facilitate increased convective flows through the cross flow channels 134. In some embodiments, bottleneck features may be introduced in the primary flow channels 124 that may, at least in part, guide flow of reactant through the cross flow channels 134 and/or across land areas. In further embodiments, certain primary flow channels 124 (e.g., every other channel) may comprise blocked ends to encourage reactant flow across land areas 132 through the cross flow channels 134.

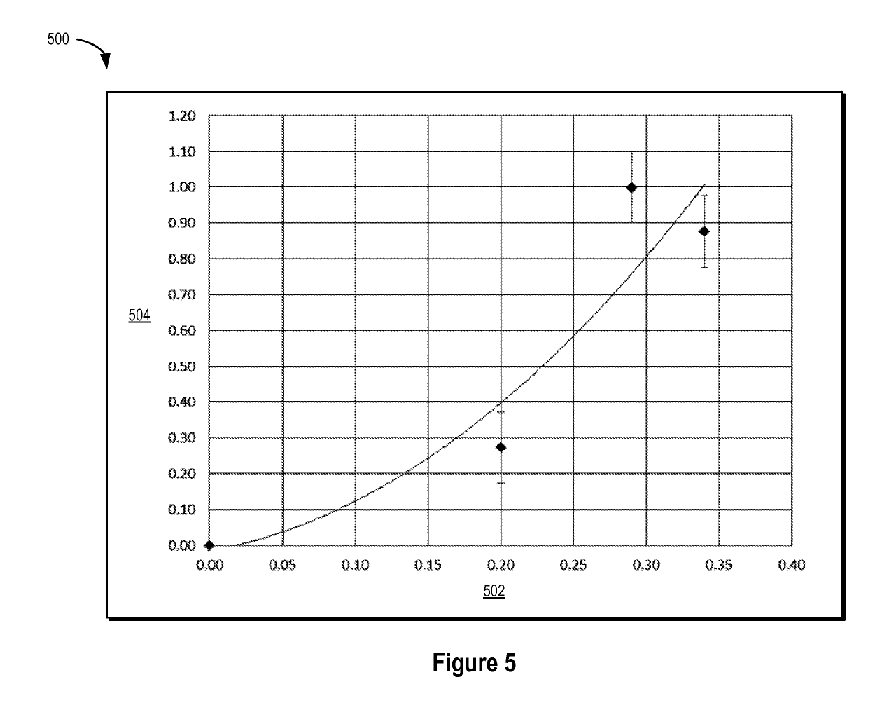

FIG. 5 illustrates a graph 500 showing exemplary normalized performance increase for a FC stack 504 at a variety of exemplary cross flow channel aspect ratios 502 consistent with embodiments disclosed herein. As illustrated in the exemplary graph 500, in some embodiments, normalized performance increase for the FC stack 504 may increase as cross flow channel aspect ratios 502 increase.

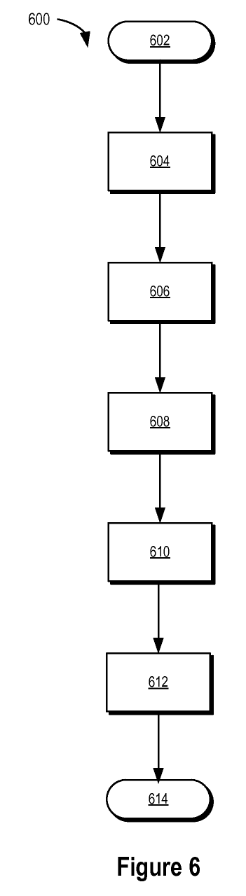

FIG. 6 illustrates a flow chart of an exemplary method 600 of assembling an FC stack consistent with embodiments disclosed herein. Particularly, method 600 may be used to assemble a FC within a FC stack consistent with embodiments disclosed herein. At 602, the method 600 may be initiated. At 604, a first bipolar plate defining a plurality of primary cathode flow channels and a plurality of cathode cross flow channels between the primary cathode flow channels may be provided. In certain embodiments, the primary cathode flow channels and cross flow channels may be configured to provide a flow path for cathode reactant.

At 606, various cathode components may be assembled. For example, a cathode gas diffusion media may be disposed adjacent to the plurality of primary cathode flow channels and the plurality of cross flow channels, a cathode microporous layer may be disposed adjacent to the cathode gas diffusion media, and a cathode catalyst layer may be disposed adjacent to the cathode microporous layer. At 608, a PEM may be disposed adjacent to the cathode catalyst layer.

At 610, various anode components may be assembled. For example, an anode catalyst layer may be disposed adjacent to the PEM, an anode microporous layer may be disposed adjacent to the anode catalyst layer, and an anode gas diffusion media may be disposed adjacent to the anode microporous layer. At 612, a second bipolar plate may be disposed adjacent to the anode gas diffusion media. In certain embodiments, the second bipolar plate may define a plurality of primary anode flow channels and a plurality of anode cross flow channels between the primary anode flow channels. In some embodiments, the primary anode flow channels and anode cross flow channels may be configured to provide a flow path for anode reactant. At 614, the method 600 may end.

Although the foregoing has been described in some detail for purposes of clarity, it will be apparent that certain changes and modifications may be made without departing from the principles thereof. For example, in certain embodiments, the systems and methods disclosed herein may be utilized in connection with FC systems not included in a vehicle. It is noted that there are many alternative ways of implementing both the processes and systems described herein. Accordingly, the present embodiments are to be considered illustrative and not restrictive, and the invention is not to be limited to the details given herein, but may be modified within the scope and equivalents of the appended claims.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

As used herein, the terms “comprises” and “includes,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection. Those having skill in the art will appreciate that many changes may be made to the details of the above-described embodiments without departing from the underlying principles of the invention. The scope of the present invention should, therefore, be determined only by the following claims.

1. A fuel cell system comprising:
a first bipolar plate, the first bipolar plate defining a plurality of primary cathode flow channels and a plurality of cathode cross flow channels between the primary cathode flow channels, the primary cathode flow channels and cathode cross flow channels being configured to provide a flow path for a cathode reactant;
a cathode disposed adjacent to the first bipolar plate;
a proton exchange membrane disposed adjacent to the cathode;
an anode disposed adjacent to the proton exchange membrane; and
a second bipolar plate disposed adjacent to the anode, the second bipolar plate defining a plurality of primary anode flow channels configured to provide a flow path for an anode reactant.

2. The fuel cell system of claim 1, wherein the second bipolar plate further defines a plurality of anode cross flow channels between the primary anode flow channels, the anode cross flow channels being configured to provide a further flow path for the anode reactant.

3. The fuel cell system of claim 1, wherein the plurality of cathode cross flow channels are defined in land areas of the first bipolar plate.

4. The fuel cell system of claim 3, wherein the cathode comprises a cathode gas diffusion media disposed adjacent to the plurality of primary cathode flow channels and the plurality of cathode cross flow channels.

5. The fuel cell system of claim 4, wherein the cathode further comprises a cathode microporous layer disposed adjacent to the cathode gas diffusion media and a cathode catalyst layer disposed adjacent to the proton exchange membrane.

6. The fuel cell system of claim 4, wherein portions of the cathode gas diffusion media intrude into the plurality of cathode cross flow channels.

7. The fuel cell system of claim 6, wherein the portions of the cathode gas diffusion media that intrude into the plurality of cathode cross flow channels are more permeable to cathode reactant flow than other portions of the cathode gas diffusion media disposed adjacent to other land areas of the first bipolar plate.

8. The fuel cell system of claim 1, wherein the cathode reactant comprise air.

9. The fuel cell system of claim 1, wherein the cathode reactant comprises oxygen.

10. The fuel cell system of claim 2, wherein the plurality of anode cross flow channels are defined in land areas of the second bipolar plate.

11. The fuel cell system of claim 10, wherein the anode comprises an anode gas diffusion media disposed adjacent to the plurality of primary anode flow channels and the plurality of anode cross flow channels.

12. The fuel cell system of claim 11, wherein portions of the anode gas diffusion media intrude into the plurality of anode cross flow channels.

13. The fuel cell system of claim 12, wherein the portions of the anode gas diffusion media that intrude into the plurality of anode cross flow channels are more permeable to anode reactant flow than other portions of the anode gas diffusion media disposed adjacent to other land areas of the second bipolar plate.

14. The fuel cell system of claim 1, wherein the anode reactant comprises hydrogen.

15. A powertrain system comprising:
a fuel cell system comprising:
a first bipolar plate, the first bipolar plate defining a plurality of primary cathode flow channels and a plurality of cathode cross flow channels between the primary cathode flow channels, the primary cathode flow channels and cathode cross flow channels being configured to provide a flow path for a cathode reactant;
a cathode gas diffusion layer disposed adjacent to the first bipolar plate;
a proton exchange membrane disposed adjacent to the cathode gas diffusion layer;
an anode gas diffusion layer disposed adjacent to the proton exchange membrane; and
a second bipolar plate disposed adjacent to the anode, the second bipolar plate defining a plurality of primary anode flow channels configured to provide a flow path for an anode reactant.

16. The system of claim 15, wherein the second bipolar plate further defines a plurality of anode cross flow channels between the primary anode flow channels, the anode cross flow channels being configured to provide a further flow path for the anode reactant.

17. The system of claim 15, wherein the cathode gas diffusion layer comprises a cathode gas diffusion media disposed adjacent to the plurality of primary cathode flow channels and the plurality of cathode cross flow channels, the plurality of cathode cross flow channels are defined in land areas of the first bipolar plate, and portions of the cathode gas diffusion media intrude into the plurality of cathode cross flow channels.

18. The system of claim 17, wherein the portions of the cathode gas diffusion media that intrude into the plurality of cathode cross flow channels are more permeable to cathode reactant flow than other portions of the cathode gas diffusion media disposed adjacent to other land areas of the first bipolar plate.

19. The system of claim 16, wherein the anode diffusion layer comprises an anode gas diffusion media disposed adjacent to the plurality of primary anode flow channels and the plurality of anode cross flow channels, the plurality of anode cross flow channels are defined in land areas of the second bipolar plate, and portions of the anode gas diffusion media intrude into the plurality of anode cross flow channels.

20. A method for assembling fuel cell system comprising:
assembling components of a fuel cell stack of the fuel cell system, wherein the assembling comprises:
providing a first bipolar plate, the first bipolar plate defining a plurality of primary cathode flow channels and a plurality of cathode cross flow channels between the primary cathode flow channels, the primary cathode flow channels and cathode cross flow channels being configured to provide a flow path for a cathode reactant;
disposing a cathode gas diffusion media adjacent to the plurality of primary cathode flow channels and the plurality of cross cathode flow channels;
disposing a cathode microporous layer adjacent to the cathode gas diffusion media;
disposing a cathode catalyst layer adjacent to the cathode microporous layer;
disposing a proton exchange membrane adjacent to the cathode catalyst layer;
disposing an anode catalyst layer adjacent to the proton exchange membrane;
disposing an anode microporous layer adjacent to the anode catalyst layer;
disposing an anode gas diffusion media adjacent to the anode microporous layer; and
disposing a second bipolar plate adjacent to the anode gas diffusion media, the second bipolar plate defining a plurality of primary anode flow channels and a plurality of anode cross flow channels between the primary anode flow channels, the primary anode flow channels and anode cross flow channels being configured to provide a flow path for an anode reactant; and
securing the assembled components of the fuel cell stack.
